(19) United States
(12) Patent Application Publication
(10) Pub. No.: US 2020/0169650 A1
(43) Pub. Date: May 28, 2020

(54) APPARATUS FOR MOUNTING OF A CAMERA OR OTHER COMPONENTS

(71) Applicants: Mark FELLINGER, Kolbermoor (DE); Gabriel PECUCH, Kolbermoor (DE)

(72) Inventors: Mark FELLINGER, Kolbermoor (DE); Gabriel PECUCH, Kolbermoor (DE)

(21) Appl. No.: 16/686,493

(22) Filed: Nov. 18, 2019

(30) Foreign Application Priority Data
Nov. 23, 2018 (DE) 10 2018 009 279.9

(51) Int. Cl. H04N 5/225; F16M 11/18; F16M 11/12; B60R 11/04; F16M 11/04

(52) U.S. Cl. CPC H04N 5/2252; F16M 11/18; B60R 2011/0056; B60R 11/04; F16M 11/041; F16M 11/12

(57) ABSTRACT

An apparatus for mounting of a camera or other components, preferably a mounting for affixation of the camera or other components to moving objects, can be fastened onto the moving objects using vacuum suction cups three-dimensionally, in simple and secure manner, and allows very good recording quality even at high speeds and in the off-road sector. The mounting includes multiple arms, wherein each arm is mounted with double articulation, and all the arms are connected with one another by way of a tilt axle and a two-part holder. A vacuum suction cup is attached at each end of an arm, in each instance, of which at least one vacuum suction cup is mounted so that it can be tilted or rotated, and all the vacuum suction cups are connected with a control device and a vacuum pump by way of at least one line, in each instance.

### CROSS REFERENCE TO RELATED APPLICATIONS

Applicant claims priority under 35 U.S.C. § 119 of German Application No. 10 2018 009 279.9 filed Nov. 23, 2018, the disclosure of which is incorporated by reference.

### BACKGROUND OF THE INVENTION

### 1. Field of the Invention

The invention relates to an apparatus for mounting of a camera or other components, preferably a mounting for affixation of the camera or other components on moving objects, wherein the mounting is fastened to the moving objects using vacuum suction cups.

### 2. Description of the Related Art

For the production of movie, television, video or advertising recordings, it is necessary to fasten the cameras used onto mountings or tripod heads, which can be pivoted in multiple axes.

In this regard, a pivoting function and a nodding function are known state of the art. The inclusion of a third axis (rolling axis) is also known, but it requires great technical effort for the production and operation of such apparatuses.

In this regard, pivoting of the mounting systems including the cameras can be carried out both manually and by means of different motor drives. Usually, stepper motors are used for this purpose, which are used by way of a rotation shaft and a control circuit for control of the pivoting/tilting function. The use of pulse counters can also be viewed as being known.

Such a pivoting/tilting camera system is known from DE 102 48 023 A1.

DE 102 08 413 B4 describes a tripod head that can be pivoted, for a camera. The tripod head can be pivoted about at least one axis using a motor drive and has a receptacle for the camera. The tripod head is composed of elements of a construction set, namely motor drive modules with a motor housing, as well as a power take-off shaft, and the motor housing has fastening devices for connection of the motor housing with a further element. In this regard, straight rods that resist bending and have clamping elements are used.

Also known is a camera holder for vehicles, having vibration damping, wherein one or more gas pressure or oil pressure shock absorbers having springs or spring elements for vibration damping are disposed in a hinge-shaped holder, relative to a hinge rotation point (DE 20 2013 007 276 U1).

From U.S. Pat. No. 7,209,176 B2, a camera holder used in Hollywood studios is known, which is fastened to a camera with multiple articulation, by way of an upper receptacle.

DE 10 2006 014 441 B4 describes an adjustment apparatus, which can be used for remote-controlled or direct adjustment of assemblies such as light sources or cameras.

It has two pivot axles and two motor units having micro-stepper motors and is constructed without a gear mechanism.

EP 2 416 202 A1 describes a camera stabilization system having a rotation axis of 360°.

From EP 1 887 274 A1, a camera head is known, which has a support arm having a vertical rotation apparatus. A U-shaped receptacle that is open toward the bottom is affixed to the rotation apparatus. The receptacle has a pivoting apparatus on its lateral arms, which apparatus is also structured in U shape and possesses a movable camera holder on its horizontal connection crosspiece.

EP 2 759 480 A1 describes a double-axis and a triple-axis ball head for use in a small unmanned flight device, in particular a drone. Both embodiments have a machine frame arrangement with different frames, which are guided within one another or engage into one another. In the inner frame, a camera receptacle is disposed, which permits a vertical inclination adjustment of the mini-camera (GoPro) by way of a U-shaped receptacle (bracket). Horizontal adjustability of the mini-camera is not possible with this arrangement. A further mounting is disposed centrally on the U-shaped receptacle, as a cantilever arm, which mounting can perform a rotational movement. At the other end of the cantilever arm, there is a fourth mounting, which again is structured in U shape and permits a further rotational movement. The apparatus is fastened to the flight device by means of this mounting. In total, the entire apparatus has three drives.

The apparatus is unsuitable for high-speed recording, because it does not have any blur protection. Only a mini-camera (GoPro) can be used as the camera technology, not a professional high-speed camera. The entire light-weight construction is preferably designed for use in mini-helicopters (drones). A closed double-cage structure is implemented.

In US 2010/0079101 A1, a camera mounting is described, which can be fastened to a car and has a stabilization system. The apparatus is preferably structured as an open tilting/rotation device, in the upper U-shaped mounting of which a camera is guided by way of a receptacle in swallowtail form. It is thereby structured as an open triple frame construction. The swallowtail-shaped camera receptacle is supported on the horizontal shank of the upper U-shaped frame by way of a central tilt joint, and can be tilted laterally to a limited extent. Furthermore, an embodiment is described, which has a triple frame. This embodiment also has no effective blur protection for high-speed recordings. This camera mounting is merely a simple holding apparatus for amateur video recordings without a professional background.

EP 0 966 154 A1 describes a method and an equipment for recordings that can be moved in three axes. In this sense, this arrangement is a triple-axis remote control system for a camera, having a joy stick as a control element and having a data line to the camera. A camera guide that can be moved in three axes is disposed below the camera—between it and the camera tripod—wherein each movement direction is achieved by way of a toothed belt/V-belt drive. This apparatus, which is also not protected against blurring, is completely unsuitable for professional high-speed recordings.

DE 42 30 838 A1 describes a tripod in a modular system, having one or more suction or adhesion feet for cameras or the like, wherein the two or more suction feet are connected in bridge-like manner by means of tubular profiles or rod profiles, and the profiles are clamped in the attachment eye, in insertable manner, and form a tubular bridge.

All the known camera mountings have the following disadvantages:
1. Three-dimensional mobility either cannot be implemented at all or can be implemented only in technically very complicated and expensive manner.
2. Vibrations occur on the mounting, which have a significant influence on the camera and thereby on the quality of the recording.
3. Due to the technically complicated designs, the mountings can be transported only with great effort and are additionally sensitive to transport damage.
4. Expensive insurance is required.
5. Due to the high production costs, only a very limited number of such mountings exist, which must be purchased or leased at high cost.
6. Most mountings cannot be affixed to vehicles or aircraft or boats, or can be affixed only in limited and complicated manner, and then insufficiently fulfill the requirements for secure fastening.
7. The known professional mountings for moving recordings have a very great inherent weight.
8. The known mountings do not have the same stability and the flexible affixation possibilities.

### SUMMARY OF THE INVENTION

An object of the invention is to provide a mounting for preferably movable camera recordings, which can be fastened to moving objects in three dimensions, in secure and simple manner, and which allows very good recording quality even at high speeds as well as in the off-road sector.

These and other objects are achieved, according to the invention, in that the mounting is made up of multiple arms, wherein each arm is mounted with double articulation, and all the arms are connected with one another by way of a tilt axle and a two-part holder, wherein a vacuum suction cup is attached at each end of an arm, in each instance, of which at least one vacuum suction cup is mounted so that it can be tilted or rotated, and all the vacuum suction cups are connected with a control device and a vacuum pump by way of at least one line, in each instance.

It has proven to be particularly effective to preferably connect three arms with one another by way of the two-part holder and its tilt axle.

The mounting can be connected with a further mounting by way of a connection piece, so that six arms, each having a suction cup, would result.

The arms are structured so that after the arms are aligned on the vehicle, they can be locked in place in a movement direction by way of a lever affixed to the tilt axle.

A further lever for locking this vacuum suction cup in place in a further movement direction is fastened onto the tilt axle of the at least one (third) arm.

The rotation axles of the other arms are structured so that they can be locked in place in a further movement direction.

The control device has a monitoring possibility for the suction forces applied to each individual vacuum suction cup.

The suction forces can be set variably or in fixed manner in different modes.

The control device has a display for constant follow-up of the current suction forces.

The control device furthermore has a function for automatic generation of a selectable suction force for all the vacuum suction cups.

The control device alternatively also has a function for manual generation of a selectable suction force for all the vacuum suction cups.

The control device furthermore has a function for reset of the suction force that is required to release the mounting from the vehicle.

The control device is connected with a rechargeable battery or with the power supply of a vehicle or with both.

Each arm has threaded bores for affixation of screw connection parts for the camera.

### ADVANTAGES OF THE INVENTION

the mounting is extremely light, at approximately 3 kg inherent weight, and is very durable in outdoor use because of its very robust construction
the software of the control device ensures a firm hold of the vacuum suction cups at all times and thereby a firm hold of the camera or other components on the vehicle (up to 100 kg carrying strength)
the mounting adheres quickly and in easy to orient manner to every component of a vehicle (three-dimensionally)
monitoring of the suction pressure and of the power supply by the control device ensures permanent and always optimal suction force (active Micro-Controlled-Vacuum-Rigging-System)
the mounting can be adapted and fixed in place three-dimensionally without any restrictions
the camera or other components, such as lighting elements, gimbals, camera heads can be fastened to each of the preferably three arms by way of fastening elements
the control device can be connected with from 11V to 30V DV (motor vehicle onboard −12V, any standard V-mount battery or also by way of D-TAB)
extremely little current is consumed during use (in automatic mode, only 0.96 W/h)
the mounting can easily be combined with a further mounting and is therefore expandable (saves space)
the mounting can be adapted and fixed in place around possible corners without any problems

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a 3-dimensional view of the entire mounting;

FIG. 2 is a top view of the mounting;

FIG. 3 is a side view of the mounting (fastened on horizontally);

FIG. 4 is a side view of the mounting (fastened on vertically);

FIG. 5 shows the mounting fastened on in space-saving, fan-like manner;

FIG. 6 shows the mounting fastened on in three different planes; and

FIG. 7 shows the mounting fastened on in angled manner.

### DETAILED DESCRIPTION OF PREFERRED EMBODIMENTS

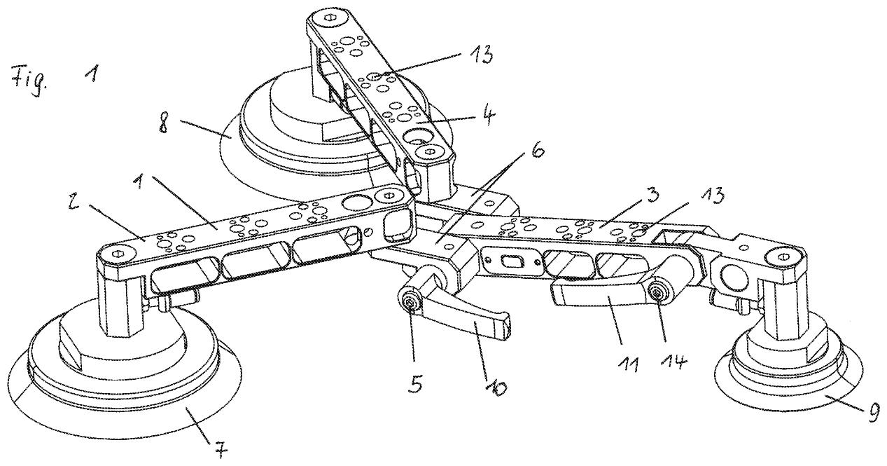

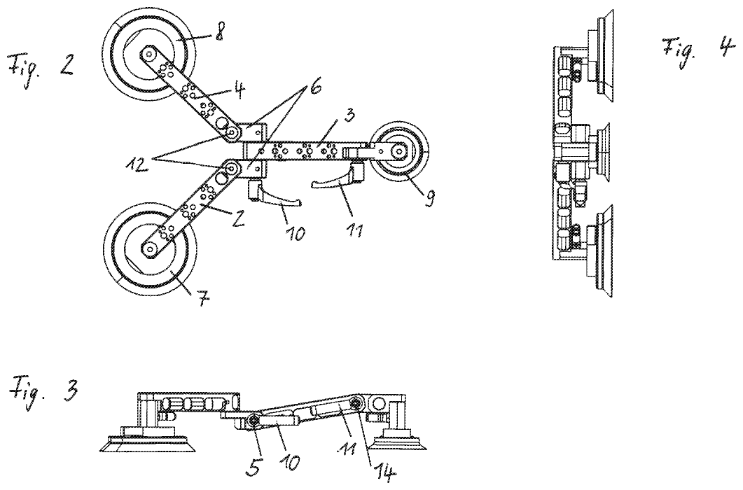

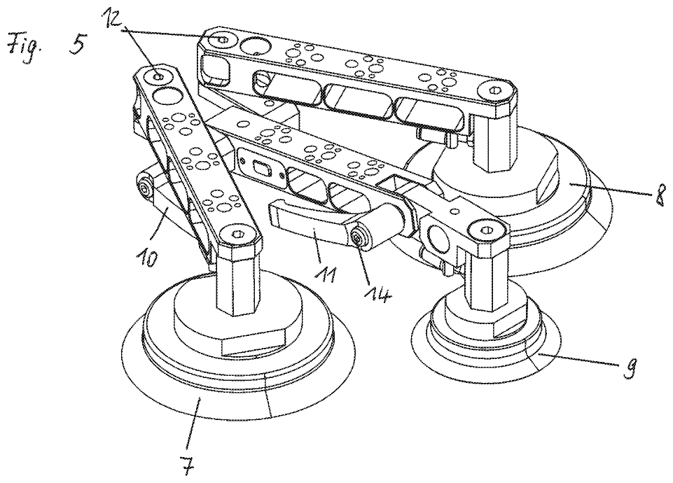

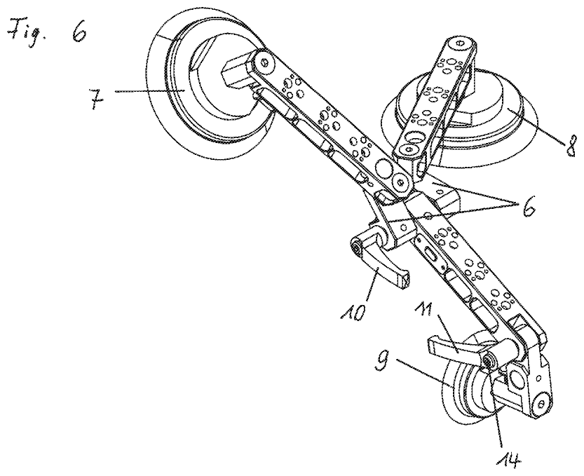

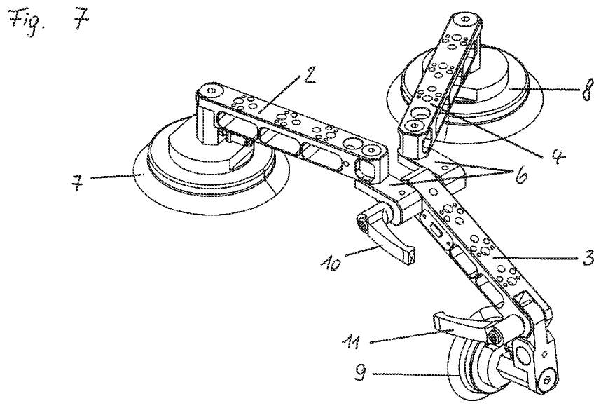

The mounting 1 shown in FIG. 1 preferably has the three arms 2, 3, 4, which are connected with one another by way of the tilt axle 5 of the two-part mounting 6. Each arm 2, 3, 4 has an associated vacuum suction cup 7, 8, 9. By way of the lever 10, the tilt axle 5 and the two-part mounting 6 with the arms 2, 3, 4 can be firmly locked in place in a movement direction. The second movement direction can be locked in place by way of locking elements (Allen screws) in the rotation axles 12 of the arms 2 and 4 after alignment on the vehicle.

The third movement direction can be locked in place by way of the lever 11 on the tilt axle 14 between arm 3 and vacuum suction cup 9.

Different threaded bores 13 are introduced on each arm 2, 3, 4 into which bores screw-connection elements of the camera or of the other components are screwed.

On the underside of each arm 2, 3, 4, guides, not shown, for the connection lines to the control device, also not shown, are arranged, which device is coupled with a vacuum pump.

Although only a few embodiments of the present invention have been shown and described, it is to be understood that many changes and modifications may be made thereunto without departing from the spirit and scope of the invention.

What is claimed is:

1. An apparatus for mounting of a camera or another component to a moving object comprising:
(a) first, second, and third arms comprising first, second, and third arm ends, respectively, wherein each of the first, second, and third arms is mounted with double articulation;
(b) a tilt axle;
(c) a two-part holder;
(d) first, second, and third vacuum cups attached to the first, second, and third arm ends, respectively;
(e) a control device; and
(f) a vacuum pump;
wherein the tilt axle and the two-part holder connects the first, second, and third arms with each other;
wherein at least one of the first, second, and third vacuum suction cups is mounted for tilting or rotation; and
wherein each of the first, second, and third vacuum cups is connected with the vacuum pump by way of at least one line.

2. The apparatus according to claim 1, further comprising a connection piece for connecting with a further mounting.

3. The apparatus according to claim 1, further comprising an arm-locking lever affixed to the tilt axle for locking the first, second, and third arms in place in a first movement direction.

4. The apparatus according to claim 3, wherein at least the third arm comprises a further tilt axle and a vacuum-suction-cup-locking lever fastened to the further tilt axle for locking the vacuum suction cup in place in a second movement direction.

5. The apparatus according to claim 4, wherein the first and second arms have first and second rotation axles, respectively, lockable in place in a third movement direction.

6. The apparatus according to claim 1 wherein the control device monitors applied suction forces of each of the first, second, and third vacuum suction cups.

7. The apparatus according to claim 6, wherein the suction forces are variable or can be firmly set in different modes.

8. The apparatus according to claim 1, wherein the control device has a display for constant monitoring of suction forces currently applied.

9. The apparatus according to claim 1, wherein the control device has a function for automatic generation of a selectable suction force at each of the first, second, and third vacuum suction cups.

10. The apparatus according to claim 1, wherein the control device has a function for manual generation of a selectable suction force at each of the first, second, and third vacuum suction cups.

11. The apparatus according to claim 1, wherein the control device has a function for reset of suction force applied by the first, second, and third vacuum suction cups.

12. The apparatus according to claim 1, wherein the control device is connected with a rechargeable battery or with a power supply of a vehicle.

13. The apparatus according to claim 1, wherein each of the first, second, and third arms has threaded bores for affixation of screw connection parts for the camera or the component.
